(19) United States
(12) Patent Application Publication
(10) Pub. No.: US 2012/0127198 A1
(43) Pub. Date: May 24, 2012

(54) SELECTION OF FOREGROUND CHARACTERISTICS BASED ON BACKGROUND

(75) Inventor: Sidhartha Gundavarapu, Hyderabad (IN)

(73) Assignee: Microsoft Corporation, Redmond, WA (US)

(21) Appl. No.: 12/951,088

(22) Filed: Nov. 22, 2010

(51) Int. Cl. G09G 5/00

(52) U.S. Cl. 345/629

(57) ABSTRACT

A text colorization system is described herein that automatically sets foreground text color based on one or more background colors over which the text is displayed. The text colorization system identifies a background color neighboring each pixel of a string of text. For each pixel region, the system selects a color to satisfy one or more colorization criteria. Next, the system sets the text color at each region based on the selected color. The system then displays the layered image to the user, such as through a computer display or mobile device display. Thus, the text colorization system provides readable text in the presence of layered graphics displays.

### BACKGROUND

Computer displays today often include layered images. One type of layered image includes a background image or color with foreground text. For example, an operating system shell may provide a desktop with a user-selectable background image/color and display icons with descriptive text on the desktop in the foreground of the image. Web pages often include images behind text or multiple layers of content. Modern search engines, such as MICROSOFT™ BING™ display a daily rotating image on their home page with text for submitting queries and selecting options of the search engine in the foreground.

Each layer of these layered images is often manually selected to produce a readable effect with proper contrast between colors in the background and the foreground. Contrast and visibility is a concern where text is involved in layered images. For example, black text over a black background will not be visible for most users. Manually viewing each of these displays at composition time so that they produce a satisfactory result at viewing time is a time consuming process.

In many cases, the same party may not control each layer of the display. For example, a user may select a background image and an application developer may display text over it, such as in the case of MICROSOFT™ Sidebar gadgets and similar layered displays. Thus, the application developer cannot select an appropriate text color because the developer has no knowledge of the underlying colors in lower layers. In addition, the colors of the image may vary at different parts of the text. For example, if the background image is a checkerboard with black and white squares, then some parts of foreground text may lie over black squares and some may lie over white squares. Setting the text to be all black or all white will still pose a problem in such situations. For more complex background images, the appropriate color for the text may vary on a pixel-by-pixel basis. Manually determining the text color for each pixel is a time consuming process that often involves the work of an artist or graphics designer to produce satisfactory results.

### SUMMARY

A text colorization system is described herein that automatically sets foreground text color based on one or more background colors over which the text is displayed. In some embodiments, the system determines and sets the text color on a character-by-character or pixel-by-pixel basis. The text colorization system identifies a background color neighboring each pixel of a string of text. For each pixel region, the system selects a color to satisfy one or more colorization criteria. Next, the system sets the text color at each region based on the selected color. The system may also set other properties of the text, such as the text brightness, text pattern, whether the text is highlighted, a font size, text emphasis, and so on. This allows the user to see the text at each location regardless of the background image. The system then displays the layered image to the user, such as through a computer display or mobile device display. Thus, the text colorization system provides readable text in the presence of layered graphics displays, even when different parties control each layer.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the text colorization system, in one embodiment.

FIG. 2 is a flow diagram that illustrates processing of the text colorization system to render layered graphics that include foreground text, in one embodiment.

FIG. 3 is a flow diagram that illustrates processing of the text colorization system to receive dynamic text configuration information, in one embodiment.

FIG. 4 is a display diagram that illustrates an example of layered graphics rendered by the text colorization system, in one embodiment.

### DETAILED DESCRIPTION

A text colorization system is described herein that automatically sets foreground text color based on one or more background colors over which the text is displayed. In some embodiments, the system determines and sets the text color on a character-by-character or pixel-by-pixel basis. The text colorization system identifies a background color neighboring each pixel of a string of text. For example, if the background image is a checkerboard with black and white squares, then the system identifies text that overlays black squares and text that overlays white squares. For each pixel region (e.g., characters, pixels, or the whole text string), the system selects a color to satisfy one or more colorization criteria. For example, an operator may configure the system to select a high contrast text color or complementary text color to the background image. Next, the system sets the text color at each region based on the selected color. For example, for regions of the text over a white square, the system may choose a black text color and for regions of the text over a black square, the system may choose a white text color.

The system may also set other properties of the text, such as the text brightness, text pattern (e.g., hash marks), whether the text is highlighted, a font size, text emphasis (e.g., bold, italics, or underlining), and so on. This allows the user to see the text at each location regardless of the background image. The system then displays the layered image to the user, such as through a computer display or mobile device display. In some embodiments, the text colorization system operates at a platform layer, such as within an operating system or web browser, to perform automatic text color selection for applications or web pages built on top of the platform. The application developer or web page developer may specify a text color code that indicates a preference for the platform to automatically select the text color based on the background color and one or more criteria (e.g., high contrast). Thus, the text colorization system provides readable text in the presence of layered graphics displays, even when different parties control each layer.

While developing applications or web sites, the font colors are determined during design time. If the font color is black, irrespective of the web page background color or background image color, the color will remain black. However, in instances where the background changes, the designer's choice of font color may not be readable over some backgrounds. The text colorization system dynamically determines the font color of the text depending on the background color or image at the time of displaying the application or web page. Most of the time, when the background of the application or web page is a standard color, the choice of the fore color can be a compatible color, but if the background is an image (e.g., a landscape) this fore color cannot be one simple compatible color, but several colors depending on the pattern of the background. The text colorization system incorporates the dynamic determination of text color into platforms that render layered graphics to select compatible colors during the rendering process. The text colorization system can be exposed as a background tool that produces a compatible selection (e.g., for web pages with rotating backgrounds, like MICROSOFT™ BING™), as an application programming interface (API) in graphical rendering APIs like MICROSOFT™ WINDOWS™ Presentation Foundation (WPF) or MICROSOFT™ DIRECTX™, or as a control in MICROSOFT™ .NET™ smart client and web technologies to enhance end user readability of rich content based applications.

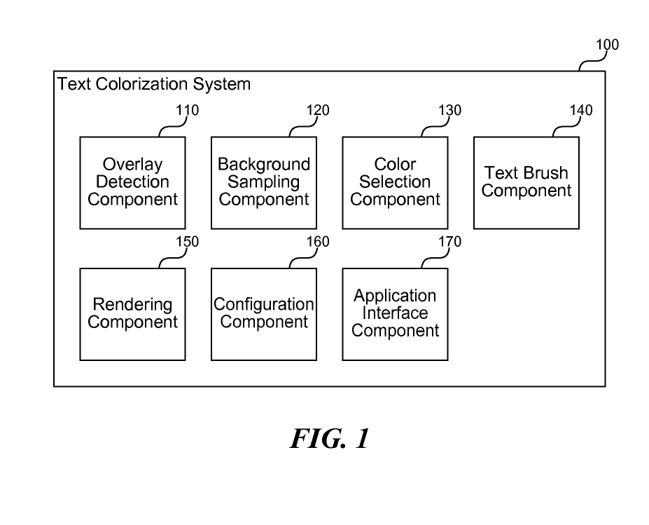

FIG. 1 is a block diagram that illustrates components of the text colorization system, in one embodiment. The system 100 includes an overlay detection component 110, a background sampling component 120, a color selection component 130, a text brush component 140, a rendering component 150, a configuration component 160, and an application interface component 170. Each of these components is described in further detail herein.

The overlay detection component 110 detects situations where foreground text is rendered on top of a variable background. For example, the component 110 may operate within a rendering engine and detect when a text layer is painted over an image layer. The component 110 may also detect text rendered over an image of the same color and kick off a second rendering pass to recolor the text. In some embodiments, the overlay detection component 110 receives notification from an application or other software code that an overlay situation exists.

The background sampling component 120 samples color information of a background image at a background location related to a foreground location where foreground text is to be rendered. For example, the component 120 may examine a rectangle that bounds the text location to identify colors, patterns, or other information related to the background that will affect the readability of text in the foreground. The background sampling component 120 may create regions, such as a pixel-by-pixel map or character-by-character map that summarize the color information found at various positions of the background image.

The color selection component 130 selects characteristics for foreground text that will allow the text to be distinguished from the background image. For example, the component 130 may invert the background color values to produce a high contrast color, or select a color that is complementary but distinguishable from the background. In some embodiments, the color selection component 130 selects other qualities of the foreground text, such as a pattern, highlighting, font weight, or other characteristics.

The text brush component 140 sets a text brush to paint text based on the selected characteristics. Graphical rendering engines commonly use brushes for applying patterns, colors, or other style information to objects to be rendered, such as text. By setting the brush, the component 140 determines the characteristics used to render the text. In some embodiments, the brush may include a bitmap or other variable image that allows a different color/pattern to be painted on one part of the text than on other parts of the text, based on variations in the background image. In some embodiments, the text brush component 140 updates the brush as the text is rendered to apply different brush characteristics to different parts of the text based on the background. For example, the brush may start out painting a light color over a dark part of the background image and vary (e.g., using a gradient) to a darker color over a light part of the image.

The rendering component 150 renders the background image and foreground text applying the selected text brush to paint the text over the background image. The rendering component may render the image in layers or compose the image in memory and render the combined bitmap to the screen. Those of ordinary skill in the art will recognize various common rendering techniques for rendering graphical layers. The system 100 enhances these techniques by dynamically selecting the text color based on characteristics of the background image, regardless of the original color of the text. In some embodiments, the system 100 receives text having characteristics set by a designer or other user and modifies the text only if the preselected text characteristics are too similar to or not visible over the current background image.

The configuration component 160 receives configuration information from a user that determines how the color selection component 130 selects characteristics for foreground text. For example, the configuration component 160 may provide settings for requesting text colors that are high in contrast, complementary, having a different pattern from the background, and so forth. The configuration information may also specify whether the system 100 is permitted to modify the text size and/or font weight to increase the readability of the text. The configuration component 160 stores the configuration information for application upon receiving a request to render layered graphics.

The application interface component 170 provides an interface through which an application can request dynamic selection of foreground text characteristics. The interface may modify existing text receiving interfaces to receive a new option for text color that requests the dynamic selection provided by the system 100. The application interface component 170 may also provide a separate API for accessing the configuration component 160 to set text selection preferences that can later be requested by the application when requesting that text be rendered.

The computing device on which the text colorization system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

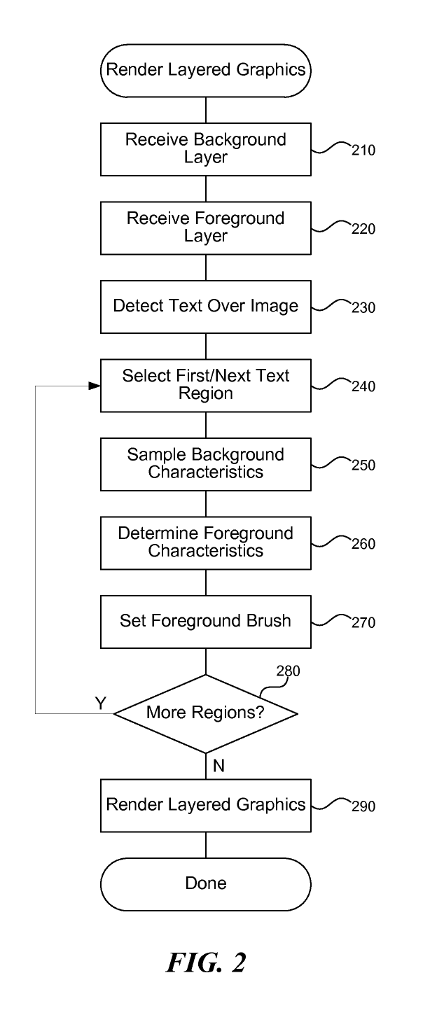

FIG. 2 is a flow diagram that illustrates processing of the text colorization system to render layered graphics that include foreground text, in one embodiment. Beginning in block 210, the system receives a background layer that includes one or more colors or patterns. The background layer may include an image, pattern, solid color, or other graphical layout. The system may operate within a rendering pipeline and receive layers to be rendered to a display of a computing device, such as a monitor or mobile device screen. In some embodiments, the system renders the background layer as soon as the background layer is received and performs the remaining steps to render the foreground layer.

Continuing in block 220, the system receives a foreground layer that includes text that is potentially difficult to read if rendered over the received background layer. For example, the foreground layer may include text that is the same color as part of the entire background layer, such that rendering the text over the background layer would make the text indistinguishable or difficult to distinguish. Continuing in block 230, the system detects whether the received foreground text will render over an incompatible portion of the background layer. Incompatibility means that the foreground text would be difficult to read or have low contrast if rendered over the background layer at the requested position.

Continuing in block 240, the system selects a first region of the foreground text for which to determine text characteristics compatible with the received background layer. For example, the system may divide the text by characters, pixels, or other regions that relate to potential variation of the background image. For background images that are solid colors, the system may consider the entire text as one region, whereas for background images that vary every few pixels the system may consider the text pixel-by-pixel or at some pixel multiple. During subsequent iterations block 240 selects the next region of the foreground text for consideration.

Continuing in block 250, the system samples one or more background characteristics at a location corresponding to the selected text region. For example, the system may identify the background image color, pattern, brightness, contrast, and so forth. The system may determine characteristics at a pixel level or summarize characteristics for a region comprising multiple pixels.

Continuing in block 260, the system determines one or more foreground text characteristics that are compatible with the sampled background characteristics. The system may determine a compatible color, pattern, brightness, contrast, or other characteristics that will allow the text to stand out and be distinguished from the background, so that a user can easily read the text. In some embodiments, the system may determine a new position for the text where the background layer has characteristics that allow a user to easily read the text.

Continuing in block 270, the system sets a foreground brush for painting the foreground layer that includes the determined foreground text characteristics and paints the selected text region using the set brush. The system may paint the text into a memory buffer and update the display after all text is rendered or paint the text directly to the display device as each region is completed. In some embodiments, the system renders the layers to a file that can be displayed later (e.g., in the case of a tool for selecting text colors). In some embodiments, when the foreground text is dynamic, the system renders the background layer as a map file and layers the foreground text dynamically (e.g., next meeting/appointment displayed on the Windows Phone lock screen).

Continuing in decision block 280, if there are more text regions, then the system loops to block 240 to select the next region, else the system continues at block 290. Continuing in block 290, the system renders the received background layer and the received foreground layer applying the determined foreground characteristics to the foreground layer to produce a graphical display in which the foreground text can be read over the background layer. After block 290, these steps conclude.

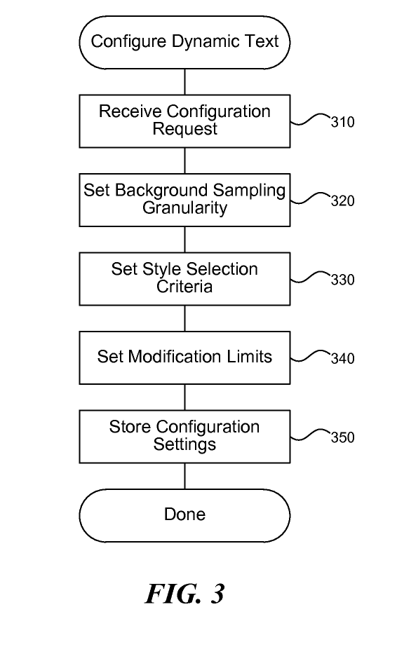

FIG. 3 is a flow diagram that illustrates processing of the text colorization system to receive dynamic text configuration information, in one embodiment. Beginning in block 310, the system receives a configuration request that specifies one or more properties for dynamically determining one or more foreground text characteristics based on a background image. For example, the system may receive the configuration request through a configuration API or control panel for modifying behavior of the text colorization system. In some embodiments, a developer of the system sets configuration information.

Continuing in block 320, the system sets a background sampling granularity based on the received request, wherein the background sampling granularity determines a size of a region of the background image to sample to determine foreground text characteristics for each region of foreground text. For example, the granularity may specify a single pixel, multiple pixels, a character-sized region, sampling based on the entire image, and so forth.

Continuing in block 330, the system sets a style selection criteria based on the received request, wherein the style selection criteria determines how foreground text characteristics are derived from sampled background characteristics. For example, the criteria may specify that the system select a color of text that is the inverse (e.g., in a 256 value RGB scale) of the background color, or that the system select a variation of the default text color that will be visible over the background. In some embodiments, the system may introduce an intermediate background layer over the background slightly larger than the text on which to paint the text so that the text can be read. The style selection criteria may affect characteristics of the intermediate layer, the text, or both.

Continuing in block 340, the system sets any modification limits based on the received request. The modification limits specify the extent to which the system can modify original foreground text characteristics to make the text more readable over the background image. For example, the limits may specify a distance function and distance from the original color of the foreground text that the text can be modified, whether the system can modify the text size or font, and so on.

Continuing in block 350, the system stores the configuration settings to a data store for access upon rendering text layered over a background image. For example, the system may store configuration settings in a configuration database or file associated with the system. After block 350, these steps conclude.

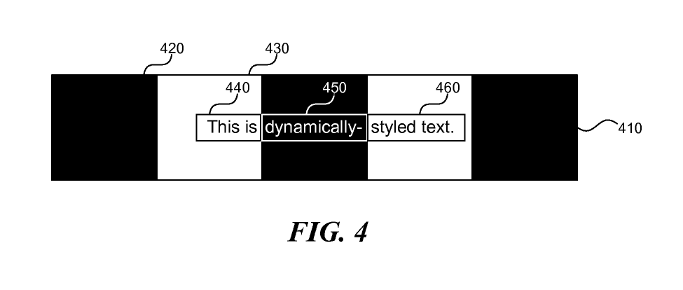

FIG. 4 is a display diagram that illustrates an example of layered graphics rendered by the text colorization system, in one embodiment. The diagram includes a background image 410 that includes multiple black checkered regions 420 and white checked regions 430. Normal text rendered over the background image using a black font would include portions that could be read and portions that were obscured by the color of the background image 410. The diagram includes text rendered by the text colorization system divided into three regions, a left region 440, a middle region 450, and a right region 460. Each region is illustrated with a box around it for clarity but the box may or may not be present in action rendered text. The left region 440 is rendered over a white checkered region 430, and thus the system selects a standard black text color for rendering the text.

The middle region, however, is rendered over a black checkered region 420 over which black text would not be visible or readable. Thus, the system selects a white text color for the middle region 450 that contrasts well with the black checkered region 420 of the background image 410. The right region 460 is rendered over a white checkered region 430 and thus the system selects a standard black text color for rendering that text. Note that the system can select a different color or other styling for the text at a character level, pixel level, or other granularity based on the degree of variation of the background image. The system could have selected a single color that would be visible over the entire background image (e.g., yellow or gray), for example.

In some embodiments, the text colorization system is built into a rendering platform associated with an operating system or web browser. Rendering platforms often receive multiple layers of content and render the layers without modification. However, the rendering platform is also in a good position to detect foreground text that will not be readable over a particular background, and to modify the text to make it readable by dynamically selecting text characteristics. The rendering platform can include an interface through which applications can communicate their preference for whether the rendering platform detects and corrects such problems, and the platform may provide user configuration options for overriding the requested behavior based on the user's preferences.

In some embodiments, the text colorization system is added to existing user interfaces. For example, the system can be implemented in JavaScript or PHP within a web page to identify instances of text that would not be visible or readable over a particular background image. The system can then modify the affected regions to produce a more readable display. The system may provide a script that web or application developers can include to perform the functions described herein.

In some embodiments, the text colorization system is provided within a control. For example, the system can be implemented in a MICROSOFT™ Windows Common Control for inclusion in desktop applications or as a MICROSOFT™ ASP.NET control for inclusion in web applications. The system may provide dynamically determined text characteristics for graphical layers managed by the control.

In some embodiments, the text colorization system provides a variety of possible text modifications. As noted herein, the modifications may include font changes, highlighting, size changes, emphasis, pulsing the text, or any other modification that calls attention to the text or makes the text more easily readable over a particular background. The text may vary at a granularity as small as pixel-by-pixel and may include color gradients or other changes that make the text suitable for reading over a particular background image.

From the foregoing, it will be appreciated that specific embodiments of the text colorization system have been described herein for purposes of illustration, but that various modifications may be made without deviating from the spirit and scope of the invention. For example, although text modifications have been described in examples herein, the system may also be applied to other types of content rendered in layers, such as icons, graphical symbols, translucent graphics, and so forth. Accordingly, the invention is not limited except as by the appended claims.

I/We claim:

1. A computer-implemented method for rendering layered graphics that include foreground text, the method comprising:
receiving a background layer that includes one or more colors or patterns;
receiving a foreground layer that includes text that is potentially difficult to read if rendered over the received background layer;
detecting whether the received foreground text will render over an incompatible portion of the background layer;
selecting a first region of the foreground text for which to determine text characteristics compatible with the received background layer;
sampling one or more background characteristics at a location corresponding to the selected text region;
dynamically determining one or more foreground text characteristics that are compatible with the sampled background characteristics;
setting a foreground brush for painting the foreground layer that includes the determined foreground text characteristics and painting the selected text region using the set brush; and
rendering the received background layer and the received foreground layer applying the determined foreground characteristics to the foreground layer to produce a graphical display in which the foreground text can be read over the background layer,
wherein the preceding steps are performed by at least one processor.

2. The method of claim 1 wherein receiving the background layer comprises receiving an multi-colored image with at least one color that matches an original color of the foreground layer.

3. The method of claim 1 wherein receiving the background layer comprises receiving layers to be rendered within a rendering pipeline to a display of a computing device.

4. The method of claim 1 further comprising, after receiving the background layer, rendering the background layer to a display device and performing the remaining steps to render the foreground layer.

5. The method of claim 1 wherein selecting the region of the foreground text comprises dividing the text by characters and determining the background characteristics underlying each character.

6. The method of claim 1 wherein selecting the region of the foreground text comprises dividing the text by pixels and determining the background characteristics underlying one or more pixels.

7. The method of claim 1 wherein sampling background characteristics comprises identifying the background image color or pattern.

8. The method of claim 1 wherein determining foreground characteristics comprises determining a compatible color, pattern, brightness, contrast, or other characteristic that will allow the foreground text to be distinguished from the background, so that a user can easily read the text.

9. The method of claim 1 wherein determining foreground characteristics comprises determining a new position for the text where the background layer has characteristics that allow a user to easily read the text.

10. The method of claim 1 wherein painting the selected text region comprises painting the text into a memory buffer and updating a display after all text is rendered.

11. The method of claim 1 wherein painting the selected text region comprises painting the text directly to a display device as each region is completed.

12. The method of claim 1 wherein painting the selected text region comprises rendering the layers to a file that can be displayed later.

13. A computer system for selection of foreground characteristics based on background, the system comprising:
a processor and memory configured to execute software instructions embodied within the following components;
an overlay detection component that detects situations where foreground text is rendered on top of a variable background;
a background sampling component that samples color information of a background image at a background location related to a foreground location where foreground text is to be rendered;
a color selection component that selects characteristics for foreground text that will allow the text to be distinguished from the background image;
a text brush component that sets a text brush to paint text based on the selected characteristics; and
a rendering component that renders the background image and foreground text applying the selected text brush to paint the text over the background image.

14. The system of claim 13 wherein the overlay detection component is further configured to operate within a rendering engine and detect a text layer being painted over an image layer.

15. The system of claim 13 wherein the background sampling component is further configured to examine a rectangle that bounds the text location to identify colors, patterns, or other information related to the background that will affect the readability of text in the foreground.

16. The system of claim 13 wherein the background sampling component is further configured to create one or more regions that summarize the color information found at various positions of the background image.

17. The system of claim 13 wherein the color selection component is further configured to invert the background color values to produce a high contrast color for foreground text.

18. The system of claim 13 wherein the text brush component is further configured to create a brush that includes a bitmap that allows a different color to be painted on one part of the text than on other parts of the text based on variations in the background image.

19. The system of claim 13 wherein the text brush component is further configured to update the brush as the text is rendered to apply different brush characteristics to different parts of the text based on the background.

20. A computer-readable storage medium comprising instructions for controlling a computer system to receive dynamic text configuration information, wherein the instructions, upon execution, cause a processor to perform actions comprising:
receiving a configuration request that specifies one or more properties for dynamically determining one or more foreground text characteristics based on a background image;
setting a background sampling granularity based on the received request, wherein the background sampling granularity determines a size of a region of the background image to sample to determine foreground text characteristics for each region of foreground text;
setting a style selection criteria based on the received request, wherein the style selection criteria determines how foreground text characteristics are derived from sampled background characteristics;
setting any modification limits based on the received configuration request, wherein the modification limits specify the extent to which the system can modify original foreground text characteristics to make the text more readable over the background image; and
storing the configuration settings to a data store for access upon rendering text layered over a background image.
